(19) United States
(12) Patent Application Publication
(10) Pub. No.: US 2010/0253975 A1
(43) Pub. Date: Oct. 7, 2010

(54) PRINT SERVER AND DATA MANAGING METHOD IN PRINT SERVER

(75) Inventors: Toshihiro Ida, Shizuoka-ken (JP); Kazuhiro Ogura, Kanagawa-ken (JP); Shinji Makishima, Shizuoka-ken (JP); Akihiro Mizutani, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/749,590

(22) Filed: Mar. 30, 2010

Related U.S. Application Data
(60) Provisional application No. 61/166,812, filed on Apr. 6, 2009.

(51) Int. Cl. G06F 15/00

(52) U.S. Cl. 358/1.15

(57) ABSTRACT

A print server includes a first input unit receiving print data from user terminals, a distribution unit distributing the print data to individual users, a storage unit storing the print data distributed to the individual users in folders of the individual users, a second input unit receiving an access request, header information of which includes apparatus information indicating an apparatus as an access source and an authenticated user name indicating an authenticated user, a user specifying unit specifying a user on the basis of the authenticated user name included in the header information received, and an output unit outputting information, which indicates the print data stored in the folder of the user specified by the user specifying unit, to the apparatus indicated by the apparatus information if the folder of the user exists in the storage unit.

### CROSS-REFERENCE TO RELATED APPLICATION

This application claims the benefit of U.S. Provisional Application No. 61/166,812, filed Apr. 6, 2009.

### TECHNICAL FIELD

The present invention relates to a print server storing print data, for example, from a user terminal connected via a network and outputting the print data in response to a request from an image forming apparatus and a data managing method in the print server.

### BACKGROUND

In the past, a network print system was known which includes a print server storing print data from a user terminal connected via a network and outputting the stored print data in response to a request from an image forming apparatus. For example, JP-A-2002-32205 discloses a system in which a server stores print data correlated with user IDs and a printer prints the print data output from the server. However, in the network print system disclosed in JP-A-2002-32205, the procedure for causing the printer to acquire desired print data from the server is complicated.

### SUMMARY

According to an aspect of the invention, there is provided a print server comprising: a first input unit configured to receive print data from user terminals; a distribution unit configured to distribute the print data received by the first input unit to individual users; a storage unit configured to store the print data distributed to the individual users by the distribution unit in folders of the individual users; a second input unit configured to receive an access request, header information of which includes apparatus information indicating an apparatus as an access source and an authenticated user name indicating an authenticated user; a user specifying unit configured to specify a user on the basis of the authenticated user name included in the header information received by the second input unit; and an output unit configured to output information, which indicates the print data stored in the folder of the user specified by the user specifying unit, to the apparatus indicated by the apparatus information if the folder of the user exists in the storage unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

### BRIEF DESCRIPTION OF THE DRAWINGS

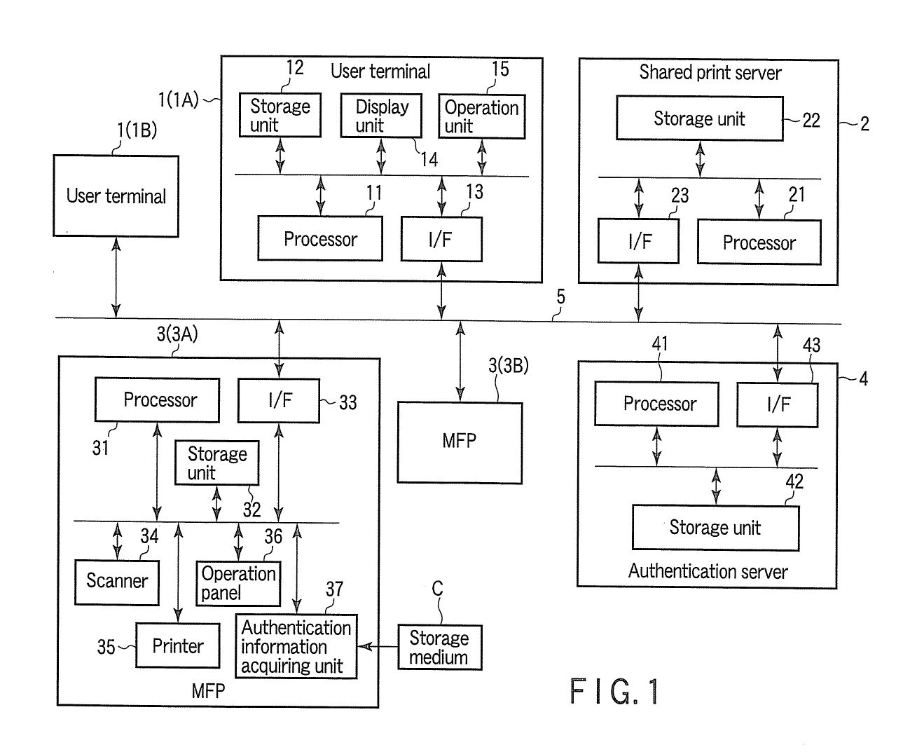

FIG. 1 is a diagram schematically illustrating the entire configuration of a network print system.

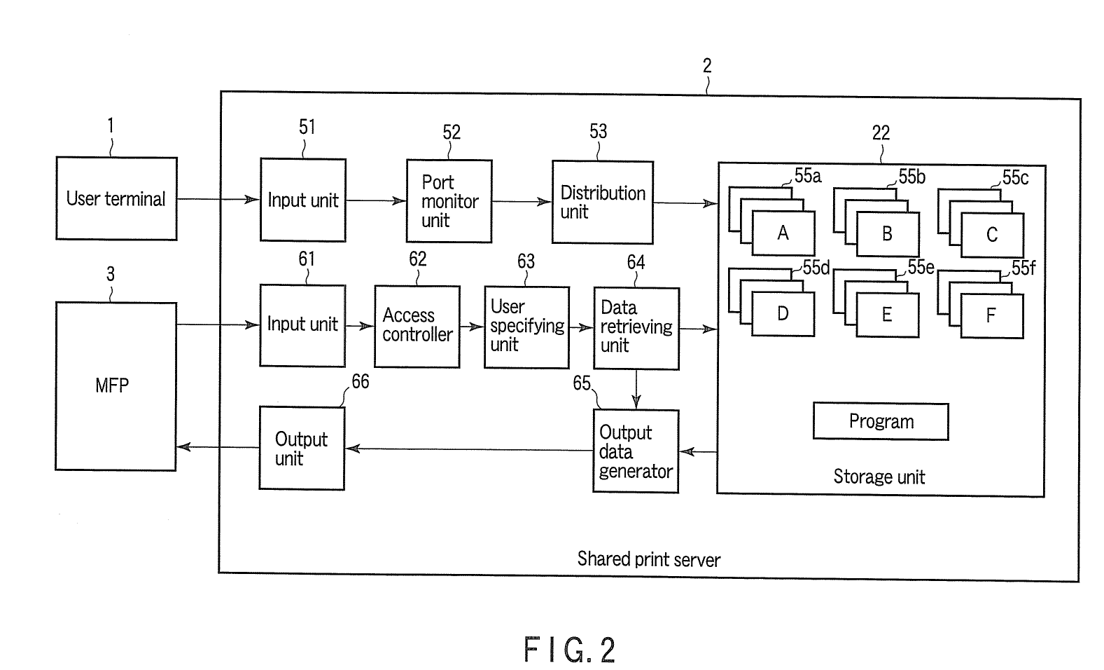

FIG. 2 is a diagram illustrating the configuration of a shared print server.

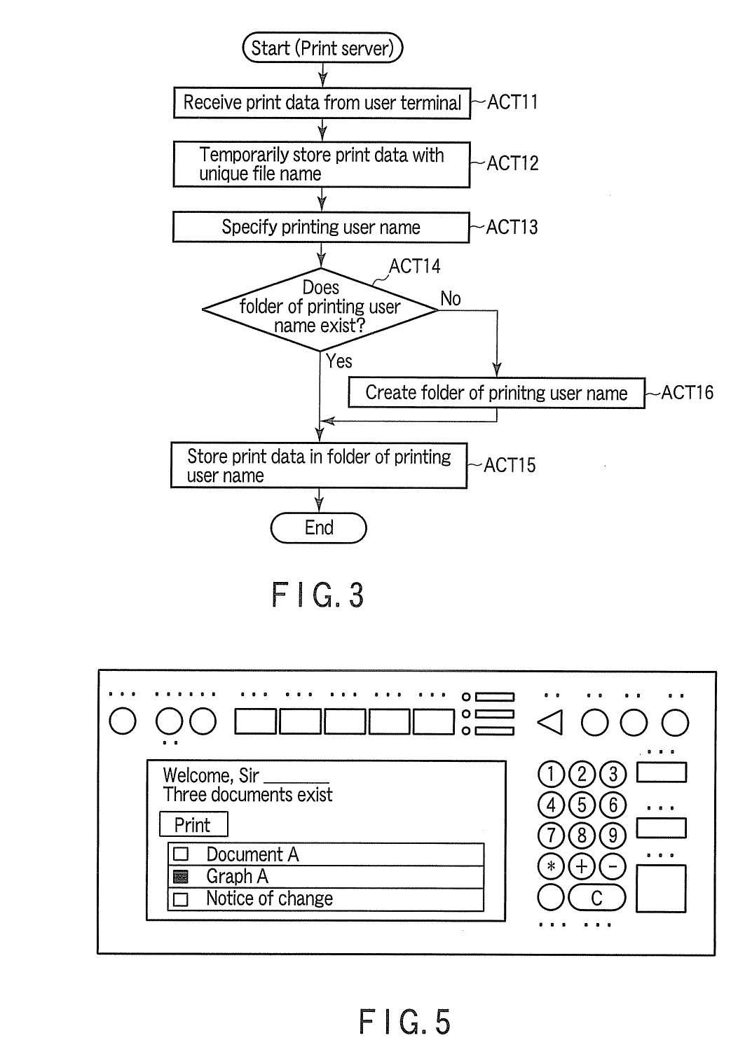

FIG. 3 is a flowchart illustrating a flow of processes in the shared print server if print data is received from a user terminal.

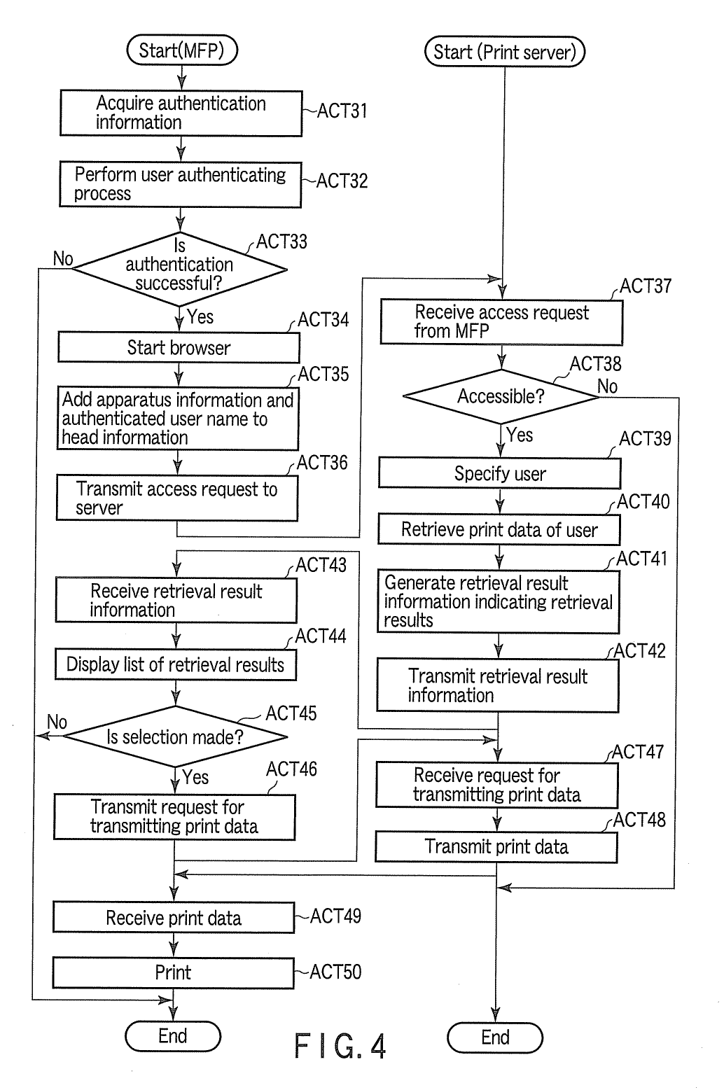

FIG. 4 is a flowchart illustrating a flow of processes if an MFP accesses the shared print server.

FIG. 5 is a diagram illustrating a display example of an operation panel of the MFP.

### DETAILED DESCRIPTION

Exemplary embodiments of the invention will be described with reference to the accompanying drawings.

FIG. 1 is a diagram schematically illustrating the entire configuration of a network print system according to an embodiment of the invention.

As shown in FIG. 1, in the network print system, plural user terminals 1 (1A and 1B), a shared print server 2, plural multi functional peripheral (MFP) 3 (3A and 3B), and an authentication server 4 are connected to each other via a network 5.

The user terminals 1 (1A and 1B) are devices used by users. Each user terminal 1 has a function of transmitting print data to the shared print server 2 via the network 5. The user terminal 1 is constructed, for example, by a personal computer (PC). In the example shown in FIG. 1, the user terminal 1 includes a processor 11, a storage unit 12, a network interface 13, a display unit 14, and an operation unit 15 as basic hardware.

The processor 11 controls the user terminal 1. The processor 11 has a function of performing various processes, for example, by executing application programs stored in the storage unit 12. For example, the processor 11 has a function of transmitting print data, which should be printed by the MFP 3, to the server 2. The storage unit 12 stores various data. The storage unit 12 includes a working memory temporarily storing data in process, a program memory storing the application programs, and a data memory storing data such as print data and user information. The network interface 13 serves to access the network 5. The processor 11 accesses apparatuses connected to the network via the network interface 13, for example, by the use of a web browser. The display unit 14 is constructed by a display device. The operation unit 15 is constructed by an operation device such as a keyboard or a mouse.

The shared print server 2 stores the print data transmitted from the user terminals 1. The shared print server 2 outputs the stored print data in response to a request from the MFP 3. The shared print server 2 classifies and stores the print data received from the user terminals 1 for the individual users. The shared print server 2 is a server computer having a function of a web server. The shared print server 2 includes a processor 21, a storage unit 22, and a network interface 23 as a basic hardware configuration.

The processor 21 controls the shared print server 2. The processor 21 has a function of performing various processes, for example, by executing application programs stored in the storage unit 22. The storage unit 22 includes a working memory temporarily storing data in process, a program memory storing the application programs, and a data memory storing data such as print data and user information. The network interface 23 serves to access the network 5. Various functions embodied by causing the processor 21 to execute the programs will be described in detail later.

The multi functional peripheral (MFP) 3 has a function of providing a user with the print data stored in the shared print server 2, or acquiring print data selected by the user from the shared print server 2 and printing the acquired print data. In the example shown in FIG. 1, the MFP 3 includes a processor 31, a storage unit 32, a network interface 33, a scanner 34, a printer 35, an operation panel 36, and an authentication information acquiring unit 37 as basic hardware configurations.

The processor 31 controls the MFP 3. The processor 31 has a function of performing various processes, for example, by executing application programs stored in the storage unit 32. For example, the processor 31 serves to control communications with the shared print server 2, to display information acquired from the shared print server 2, or to perform a printing process using the print data acquired from the shared print server 2. In this embodiment, it is assumed that the MFP 3 has a browsing function using a web browser (Embedded Web Browser: EWE) and the processor 31 communicates with the shared print server 2 by the use of a communication function (for example, HTTP communication) of the web browser.

The storage unit 32 includes a working memory temporarily storing data in process, a program memory storing the application programs, and a data memory storing data such as print data and user information. The storage unit 32 may store the information such as user authentication results by the use of cookies. As storage places of cookies, cookie areas for individual users may be disposed in the data memory of the storage unit 32. The cookie areas for the individual users may be a memory area which can be accessed by the MFP 3 and may be disposed, for example, in an external storage device, a server, or a user terminal.

The network interface 33 serves to access the network 5. The processor 31 accesses devices connected to the network via the network interface 33, for example, by the use of the web browser. The scanner 34 serves to read an image. The printer 35 prints the image on a sheet on the basis of the print data. The operation panel 36 is a user interface including a display unit and an operation unit. For example, the operation panel 36 includes a liquid crystal display unit having a built-in touch panel and a panel having hard keys. In this case, an operation guide or touch keys are displayed on the display unit of the operation panel 36.

The authentication information acquiring unit 37 serves to acquire authentication information of a user. In the example shown in FIG. 1, the authentication information acquiring unit 37 reads the authentication information stored in a storage medium carried by the user. An IC card, a memory card, a portable memory, or a portable terminal device can be used as the storage medium. However, the authentication information acquiring unit 37 is not limited to reading information from the storage medium, but may be a device for acquiring authentication information from a user.

For example, a user ID and a password may be used as the user's authentication information. If the user ID and the password are used as the user's authentication information, the operation panel 36 may serve as the authentication information acquiring unit 37. Biological information such as a fingerprint may be used as the user's authentication information. If the biological information is used as the user's authentication information, the authentication information acquiring unit 37 may be constructed by a device acquiring the biological information from the user.

In this embodiment, an IC card carried by each user is assumed as the storage medium. In this case, the IC card C stores the authentication information of a user as an owner. The IC card C may be a non-contact type IC card (an IC card making wireless data communication) or may be a contact type IC card (an IC card making data communication via a contact portion).

The authentication server 4 is a server of authenticating a user on the basis of the authentication information supplied from the MFP 3. The authentication function of the authentication server 4 may be disposed in the MFP 3 or may be disposed in the shared print server. In this embodiment, the authentication result for the authentication information acquired by the authentication information acquiring unit 37 of the MFP 3 is returned to the MFP 3. If the user authentication is successfully performed by the authentication server 4, the MFP 3 considers the successfully-authenticated user logged in and activates the web browser. In the example shown in FIG. 1, the authentication server 4 includes a processor 41, a storage unit 42, and a network interface 43 as basic hardware configurations.

The processor 41 controls the authentication server 4. The processor 41 has a function of performing various processes, for example, by executing application programs stored in the storage unit 42. For example, the processor 41 authenticates a user depending on whether the authentication information supplied from the MFP 3 corresponds to the authentication information (registered user information) of a registered user stored in the storage unit 42. The storage unit 42 includes a working memory temporarily storing data in process, a program memory storing the application programs, and a data memory storing data such as print data and user information. The network interface 43 serves to access the network 5.

The configuration of the shared print server 2 will be described below.

FIG. 2 is a diagram illustrating the configuration of the shared print server 2.

As shown in FIG. 2, the shared print server 2 includes a first input unit 51, a port monitor unit 52, and a distribution unit 53 as processing functions until the print data from the user terminal 1 is stored in the storage unit 22. The shared print server 2 includes a second input unit 61, an access controller 62, a user specifying unit 63, a data retrieving unit 64, an output data generator 65, and an output unit 66 as processing functions of outputting the print data in response to the access from the MFP 3.

The processor 21 shown in FIG. 1 includes the port monitor unit 52, the distribution unit 53, the access controller 62, the user specifying unit 63, the data retrieving unit 64, and the output data generator 65. The functions of the units are embodied by causing the processor 21 of the shared print server 2 to execute the programs stored in the storage unit 22. The interface 23 includes the first input unit 51, the second input unit 61, and the output unit 66.

First, the first input unit 51 serves as an interface receiving the print data from the user terminals 1. The port monitor unit 52 stores the print data received from the user terminals 1 in a temporary storage place with unique file names. The temporary storage place may be a storage area disposed in the storage unit 22 or may be a buffer memory (not shown) disposed in the interface 23 or the like.

The distribution unit 53 serves to distribute the print data to the individuals. The distribution unit 53 determines a printing user name of the print data, for example, by extracting a personal name (printing user name) from the print job language (PJL) of the print data. If the printing user name is determined, the distribution unit 53 distributes the print data to the individual folders disposed in the storage unit 22. If a folder of the printing user name extracted from the print data exists, the distribution unit 53 distributes and stores the print data, to which the unique file name is given by the port monitor unit 52, to and in the folder of the corresponding printing user. If the folder of the printing user name extracted from the print data does not exist, the distribution unit 53 generates a folder of the printing user name in the storage unit 22 and stores the print data, which the unique file name is given to by the port monitor unit 52, in the folder. By performing the above-mentioned functions, the shared print server 2 distributes and stores the print data received from the user terminals 1 to and in the individual folders in the storage unit 22.

The second input unit 61 serves as an interface receiving an access request from the MFP 3. In this embodiment, the shared print server 2 serves as a web server and the MFP 3 has a web browser function. The shared print server 2 and the MFP 3 make HTTP communication with each other. In the HTTP communication, there is an item called a user agent as the header information. If it accesses the print data stored in the shared print server 2, the MFP 3 adds a successfully-authenticated user name (authenticated user name) to the user agent item, as well as the information (apparatus information) indicating the MFP 3 as an access source, as the header information of the HTTP communication. That is, the second input unit 61 receives the access request including the apparatus information indicating the MFP (the apparatus as the access source) and the authenticated user name from the MFP 3.

The access controller 62 controls the access on the basis of the information received from the MFP 3 by the second input unit 61. If the shared print server 2 is a web server and there is no restriction to access, the apparatuses connected to the network can access the server 2 by the browser without limitation. Accordingly, the shared print server 2 causes the access controller 62 to control the access. For example, the access controller 62 controls the access using the IP address. In this case, the access controller 62 controls the accesses from the apparatuses on the basis of the right of access set to be correlated with the IP addresses. The access controller 62 may use the client authentication in the SSL communication as the access control method. In this case, a client certificate is installed in the MFP which can access the shared print server 2. Then, the access controller 62 can cause a browser other than the MFP having no client certificate not to access.

The user specifying unit 63 specifies an authenticated user name indicating an accessing user. In the above-mentioned example, the header information of the HTTP communication received from the MFP 3 includes the apparatus information and the authenticated user name. The user specifying unit 63 extracts the authenticated user name included in the header information of the HTTP communication received from the MFP 3. The extracted authenticated user name is information indicating an accessing user. That is, the user specifying unit 63 specifies the authenticated user name indicating an accessing user from the header information of the HTTP communication received from the MFP 3.

The data retrieving unit 64 retrieves the print data of the individual users. For example, the data retrieving unit 64 retrieves the entire print data stored in the folder of the corresponding user name if the authenticated user name (user name) is specified. In this case, the data retrieving unit 64 outputs title information (list of print data) of the entire print data stored in the folder of the user name as the retrieval result. The title information can show the details of the print data, such as file names. The title information is information serving as a key for causing a user to select the print data in the MFP 3. If the folder of the specified authenticated user name (user name) does not exist in the storage unit 22, the data retrieving unit 64 outputs a message indicating that the print data of the user does not exist as the retrieval result.

The output data generator 65 outputs information indicating the retrieval result of the print data by the data retrieving unit 64. For example, if the data retrieving unit 64 could retrieve the title information (list of print data) of the user's print data, the output data generator 65 generates retrieval result information indicating the title information of the user's print data as the output data. If the data retrieving unit could not retrieve the user's print data (if the user's print data does not exist), the output data generator 65 generates retrieval result information indicating that the user's print data does not exist as the output data.

The output unit 66 outputs the retrieval result information as the retrieval result of the user's print data generated by the output data generator 65. The MFP 3 receiving the retrieval result information output from the output unit 66 of the shared print server 3 displays a list of the user's print data as the retrieval result information acquired from the shared print server 3. If the user selects the print data to be printed from the print data displayed in the list, the MFP 3 transmits a request for transmitting the selected print data to the shared print server 3. If receiving the request for transmitting the specific print data from the MFP 3 after outputting the retrieval result information, the shared print server 2 reads the specified print data from the storage unit 22 and outputs the read print data to the MFP 3.

A flow of processes of causing the shared print server 2 to store the print data received from the user terminal 1 will be described below.

FIG. 3 is a flowchart illustrating the flow of processes of storing the print data received from the user terminal 1.

First, the shared print server 2 inputs the print data received from the user terminal 1 by the interface 23 by the use of the function of the first input unit 51 (ACT 11). If the print data is received from the user terminal 1, the processor 21 of the shared print server 2 temporarily stores the print data received by the use of the function of the port monitor unit 52 in a storage area with a unique file name (ACT 12).

If the received print data is temporarily stored, the processor 21 distributes the print data to the individual users by the use of the function of the distribution unit 53 and stores the distributed print data in the storage unit 22 (ACTs 13 to 16). First, the processor 21 extracts a user name (printing user name) from the print job language (PJL) of the received print data and determines the printing user name of the print data (ACT 13).

If the printing user name of the received print data is determined, the processor 21 determines whether the folder of the printing user name exists in the storage unit 22 (ACT 14). If the folder of the printing user name extracted from the received print data exists in the storage unit 22 (YES in ACT 14), the processor 21 stores the print data with a unique file name given thereto in the folder of the printing user name (ACT 15).

If it is determined that the folder of the printing user name extracted from the received print data does not exist in the storage unit 22 (NO in ACT 14), the processor 21 generates a folder of the printing user name in the storage unit 22 (ACT 16). If the folder of the printing user name is generated in the storage unit 22, the processor 21 stores the print data with the unique file name given thereto in the folder of the printing user name (ACT 15).

According to the above-mentioned processes, the shared print server 2 can distribute and store the print data received from the user terminal 1 in the folders (individual folders) generated in the storage unit 22 for the individuals.

A flow of processes of causing the MFP 3 to access the shared print server 2 will be described below.

FIG. 4 is a flowchart illustrating the flow of processes of causing the MFP 3 to access the shared print server 2.

First, the MFP 3 causes a user to input authentication information. In this embodiment, it is assumed that the user inputs the authentication information using an IC card. In this case, the user feeds his or her IC card to a card reader as the authentication information acquiring unit 37 of the MFP 3. If the IC card is fed by the user, the processor 31 instructs the card reader as the authentication information acquiring unit 37 to read the user's authentication information from the IC card fed by the user and acquires the information read by the card reader (ACT 31). At this time, a message for guiding the feeding of the user's IC card may be displayed in the operation panel 36 of the MFP 3.

If the authentication information acquiring unit 37 acquires the user's authentication information from the IC card, the processor 31 of the MFP 3 performs a user authenticating process based on the acquired authentication information (ACT 32). For example, the processor 31 requests the authentication server 4 to authenticate the user by transmitting the acquired authentication information to the authentication server 4. Then, the authentication server 4 authenticates the user by combining the authentication information received from the MFP 3 with the authentication information of the registered user registered in the storage unit and transmits the authentication result to the MFP 3. The user authenticating function may be mounted on the MFP 3. In this case, the processor 31 authenticates the user by combining the received authentication information with the authentication information of the registered user registered in the storage unit of the MFP 3 or in an external storage device.

If the user authentication in the user authenticating process is successful (that is, if the user can be uniquely specified) (YES in ACT 33), the processor 31 of the MFP 3 logs in with the authenticated user name and starts up the web browser (ACT 34). If the web browser is started up, the processor 31 of the MFP 3 adds the apparatus information for specifying the MFP 3 and the authenticated user name (the successfully-authenticated user name) to the access request to the shared print server 2 (ACT 35) and transmits the access request to the shared print server 2 (ACT 36). For example, in this embodiment, the processor 31 adds the authenticated user name to the user agent item in the header information of the HTTP communication.

If the shared print server 2 receives the access request from the MFP 3 (ACT 37), the processor 21 determines whether the MFP has right of access on the basis of the information received from the MFP 3 by the use of the function of the access controller 62 (ACT 38). For example, if the access is controlled using the IP address, the processor 21 determines whether the access of the MFP 3 as the transmission source of the access request should be permitted on the basis of the right of access set to correspond to the IP address. If the access is controlled using the client certificate, the processor 21 determines whether the access should be permitted, depending on whether the MFP 3 as the transmission source of the access request has the client certificate.

If it is determined that the access from the MFP 3 is permitted (YES in ACT 38), the processor 21 specifies the authenticated user name of the user requesting the access by the use of the function of the user specifying unit 63 (ACT 39). For example, the processor 21 extracts the authenticated user name included in the header information of the HTTP communication received from the MFP 3 and specifies the extracted authenticated user name as the user name.

If the user name is specified, the processor 21 retrieves the print data of the user name by the use of the function of the data retrieving unit 64 (ACT 40). For example, the processor 21 determines whether the folder of the user name exists in the storage unit 22.

If it is determined that the folder of the user name exists in the storage unit 22, the processor 21 sets the title information of the entire print data (the list of print data) existing in the folder of the user name as the retrieval result. If it is determined that the folder of the user name does not exist in the storage unit 22, the processor 21 sets the non-existence of the user's print data as the retrieval result.

If the retrieval of the user's print data using the user name is ended, the processor 21 generates the retrieval result information indicating the retrieval result of the print data as the output data by the use of the function of the output data generator 65 (ACT 41). If the folder of the user name exists, the processor 21 generates the title information of the entire print data (the list of print data) existing in the folder of the user name as the retrieval result information. If the folder of the user name does not exist, the processor 21 generates the non-existence of the user's print data as the retrieval result information. If the retrieval result information is generated, the processor 21 transmits the retrieval result information to the MFP 3 as the transmission source of the access request (ACT 42).

If the MFP 3 receives the retrieval result information corresponding to the access request from the shared print server 2 (ACT 43), the processor 31 displays the received retrieval result information on the operation panel 36 (ACT 44). For example, if receiving the retrieval result information indicating that the print data does not exist, the processor 31 displays a message indicating the non-existence of the user's print data on the operation panel 36.

If receiving the retrieval result information including the title information of at least one piece of print data, the processor 31 displays the list of the title information of the entire print data on the operation panel 36. The title information of the print data is displayed in a state where the user can select it. For example, if the operation panel 36 includes a display unit having a built-in touch panel, the title information of the print data is displayed in a list on the display unit of the operation panel 36 so that the user can select the print data using the touch panel. FIG. 5 is a diagram illustrating a display example where the title information of print data is displayed in a list. In the list shown in FIG. 5, the user names and the number of print data of the user names are guided and the title information of the print data is displayed so that it can be selected.

If the user selects one piece of print data from the list displayed on the operation panel 36 (YES in ACT 45), the processor 31 of the MFP 3 transmits a request for transmitting the selected print data to the shared print server 2 (ACT 46). Here, it is assumed that the MFP 3 and the shared print server 2 have the right of access. Accordingly, if the shared print server 2 receives the request for transmitting the specified print data from the MFP 3 (ACT 47), the processor 21 reads the specified print data from the storage unit 22 and transmits the read print data to the MFP 3 (ACT 48).

If the MFP 3 receives the print data transmitted from the shared print server 2 (ACT 49), the processor 31 performs a printing operation based on the received print data by the use of the printer 35 (ACT 50). The MFP 3 may display the print data transmitted from the shared print server 2 on the operation panel 36 or may store the print data in a storage medium, instead of printing the print data.

As described above, in the network print system according to this embodiment, it is possible to easily acquire the print data for the individual users from the shared print server having the function of a web server by the use of the web browser function installed in the MFP. For example, if the MFP accesses the shared print server, the MFP adds the authenticated user name as a user agent to the header of the HTTP communication. Accordingly, the shared print server can easily identify the MFP as the access source and the user name (authenticated user name) included in the access request from the MFP and can easily access the storage areas provided for the individual users. As a result, the MFP can easily acquire the information on the print data of the authenticated user from the shared print server and can efficiently manage the print data using the shared print server.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A print server comprising:
a first input unit configured to receive print data from user terminals;
a distribution unit configured to distribute the print data received by the first input unit to individual users;
a storage unit storing the print data distributed to the individual users by the distribution unit in folders of the individual users;
a second input unit configured to receive an access request, header information of which includes apparatus information indicating an apparatus as an access source and an authenticated user name indicating an authenticated user;
a user specifying unit configured to specify a user on the basis of the authenticated user name included in the header information received by the second input unit; and
an output unit configured to output information, which indicates the print data stored in the folder of the user specified by the user specifying unit, to the apparatus indicated by the apparatus information if the folder of the user exists in the storage unit.

2. The server according to claim 1, wherein the distribution unit extracts a user name from the print data received by the first input unit and distributes the print data to the individual users on the basis of the extracted user name.

3. The server according to claim 1, further comprising a port monitor unit configured to store the print data received by the first input unit with a unique file name,
wherein the distribution unit extracts a user name from the print data stored with the unique file name by the port monitor unit and distributes the print data to the individual users on the basis of the extracted user name.

4. The server according to claim 1, further comprising an access controller configured to determine whether the apparatus as the access source indicated by the apparatus information has right of access if the access request is received by the second input unit,
wherein the output unit outputs data to the apparatus as the access source if the access controller determines that the apparatus as the access source has the right of access.

5. The server according to claim 4, wherein the access controller determines whether the apparatus as the access source has the right of access using an IP address of the apparatus as the access source indicated by the apparatus information.

6. The server according to claim 4, wherein the access controller determines whether the apparatus as the access source has the right of access, depending on whether the apparatus as the access source indicated by the apparatus information has a client certificate.

7. A data managing method in a print server comprising:
receiving print data from user terminals;
distributing the received print data to individual users;
storing the print data distributed to the individual users in folders of the individual users;
receiving an access request, header information of which includes apparatus information indicating an apparatus as an access source and an authenticated user name indicating an authenticated user;
specifying a user on the basis of the authenticated user name included in the received header information; and
outputting information, which indicates the print data stored in the folder of the specified user, to the apparatus indicated by the apparatus information if the folder of the specified user exists in the storage unit.

8. The method according to claim 7, wherein the distributing of the received print data includes extracting a user name from the received print data and distributing the print data to the individual users on the basis of the extracted user name.

9. The method according to claim 7, further comprising temporarily storing the received print data with a unique file name,
wherein the distributing of the received print data includes extracting a user name from the print data temporarily stored with the unique file name and distributing the print data to the individual users on the basis of the extracted user name.

10. The method according to claim 7, further comprising determining whether the apparatus as the access source indicated by the apparatus information has right of access if the access request is received,
wherein the outputting of the information includes outputting data to the apparatus as the access source if it is determined that the apparatus as the access source indicated by the apparatus information has the right of access.

11. The method according to claim 10, wherein the determination on the right of access includes determining whether the apparatus as the access source has the right of access using an IP address of the apparatus as the access source indicated by the apparatus information.

12. The method according to claim 10, wherein the determination on the right of access includes determining whether the apparatus as the access source has the right of access, depending on whether the apparatus as the access source indicated by the apparatus information has a client certificate.

13. A network print system comprising a print server and an image forming apparatus,
wherein the print server comprises:
a first input unit configured to receive print data from user terminals;
a distribution unit configured to distribute the print data received by the first input unit to individual users;
a storage unit configured to store the print data distributed to the individual users by the distribution unit in folders of the individual users;
a second input unit configured to receive an access request, header information of which includes apparatus information indicating an image forming apparatus and an authenticated user name indicating an authenticated user, from the image forming apparatus;
a user specifying unit configured to specify a user on the basis of the authenticated user name included in the header information received by the second input unit; and
an output unit configured to output information, which indicates the print data stored in the folder of the user specified by the user specifying unit, to the image forming apparatus indicated by the apparatus information if the folder of the user exists in the storage unit, and
wherein the image forming apparatus comprises:
an authentication information acquiring unit configured to acquire user's authentication information;
a transmitter unit configured to transmit the access request, the header information of which includes the apparatus information indicating the image forming apparatus and the authenticated user name indicating a user authenticated using the authentication information, to the print server if the authentication using the authentication information acquired by the authentication information acquiring unit is successful;
a display unit configured to display information indicating the received print data if the information indicating the print data of the user with the authenticated user name is received from the print server; and
a data acquiring unit configured to acquire the print data, which is selected from the print data displayed on the display unit by the user, from the print server.

14. The system according to claim 13, wherein the distribution unit of the print server extracts a user name from the print data received by the first input unit and distributes the print data to the individual users on the basis of the extracted user name.

15. The system according to claim 13, wherein the print server further comprises a port monitor unit configured to store the print data received by the first input unit with a unique file name,
wherein the distribution unit of the print server extracts a user name from the print data stored with the unique file name by the port monitor unit and distributes the print data to the individual users on the basis of the extracted user name.

16. The system according to claim 13, wherein the print server further comprises an access controller configured to determine whether the image forming apparatus as the access source indicated by the apparatus information has right of access if the access request is received by the second input unit,
wherein the output unit of the print server outputs data to the image forming apparatus as the access source indicated by the apparatus information if the access controller determines that the image forming apparatus as the access source has the right of access.

17. The system according to claim 16, wherein the access controller of the print server determines whether the image forming apparatus as the access source has the right of access using an IP address of the image forming apparatus as the access source indicated by the apparatus information.

18. The system according to claim 16, wherein the access controller of the print server determines whether the image forming apparatus as the access source has the right of access, depending on whether the image forming apparatus as the access source indicated by the apparatus information has a client certificate.

19. The system according to claim 13, wherein the image forming apparatus further comprises an authentication processor transmitting the authentication information acquired by the authentication information acquiring unit to an authentication server and receiving the authentication result of the authentication information from the authentication server.

20. The system according to claim 13, wherein the image forming apparatus further comprises an authentication processor combining the authentication information acquired by the authentication information acquiring unit with registered user information.
